(19) United States
(12) Patent Application Publication
(10) Pub. No.: US 2013/0080260 A1
(43) Pub. Date: Mar. 28, 2013

(54) Targeted Digital Media Content

(71) Applicants: Paul B. French, Cork (IE); Niall J. Lucey, Cork (IE); Michael Truss, Cork (IE)

(72) Inventors: Paul B. French, Cork (IE); Niall J. Lucey, Cork (IE); Michael Truss, Cork (IE)

(73) Assignee: International Business Machines Corporation, Armonk, NY (US)

(21) Appl. No.: 13/528,651

(22) Filed: Jun. 20, 2012

(30) Foreign Application Priority Data
Sep. 22, 2011 (GB) 11182351.4

(51) Int. Cl. G06Q 30/02

(52) U.S. Cl. 705/14.66

(57) ABSTRACT

Method and system is provided for targeted digital media content delivery. The method includes: receiving activation of the targeting service by a consumer; determining a first value of a human emotion metric corresponding to the mood of a consumer at a first time before or while consuming digital media content; determining a second value of that human metric at a second time while consuming the digital media content. The method also includes: comparing the first value of human emotion metric with the second value in order to determine a change in emotion of the consumer; and targeting the media content in accordance with the change in emotion of the consumer.

### BACKGROUND

This invention relates to the field of digital media content delivery. In particular, the invention relates to targeted digital media content delivery for a consumer.

Digital media content, including advertisements, films, shows, music, etc., may be adapted to a consuming person's preferences to achieve personalisation of content. Such preferences may be input by a consumer via an interface or automatically determined.

It is becoming more important for vendors and consumers to target accurately the correct market and to be targeted correctly.

The viewing public is also becoming less tolerant of advertisements that are not relevant to their circumstances and may change channel to avoid irrelevant advertisements.

Systems are known which adapt delivered content to a consuming person's emotion. The emotion of a consuming person may be measured and used to determine appropriate content to be delivered. In this way, the interest of a consuming person may be determined and the content changed appropriately.

Such systems may determine static emotional states such as anger, happiness, fear, sadness and provide appropriate content. However, there is no system which measures the emotional reaction of a consumer to the content and taking action based on the reaction.

Therefore, there is a need in the art to address the aforementioned problem.

### SUMMARY

According to a first aspect of the present invention there is provided a method for targeted digital media content delivery, comprising: receiving activation of a targeting service by a consumer; determining a first value of a human emotion metric corresponding to a mood of the consumer at a first time; determining a second value of the human emotion metric at a second time corresponding to the mood of the consumer while consuming digital media content; comparing the first value of the human emotion metric with the second value of the human emotion content in order to determine a change in emotion of the consumer; and targeting the digital media content in accordance with the change in emotion of the consumer.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a flow diagram of an embodiment of a method in accordance with the present invention;

FIG. 2 is a block diagram of an embodiment of a system in accordance with the present invention; and

FIG. 3 is a block diagram of a computer system in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Method and system are described for targeted digital media content delivery which, with the consent of a consumer, targets delivered content in response to the consumer's reaction to the content. A first value of a human emotion metric corresponding to the mood of a consumer is determined at a first time either before or during consumption of digital media content, and a second value of that human metric is determined at a second time during consumption of the digital media content. The change in a consumer's emotion is measured by comparing the first value of human emotion metric with the second value and delivered content is adjusted according to the change in emotion. In this way, a consumer's reaction to the digital media content is measured and the delivered content can be targeted in response to the reaction.

Changes within a particular emotion are measured. For example, once fear is measured, the described system continues to measure the change in that level of fear. For example, is the consumer becoming more or less afraid, by how much and at what rate? This change in emotion indicates the reaction of a person to consuming the media content.

Determining a change in emotion overcomes the difficulty that a person may already have a strong emotion prior to consuming the media content. In the described system, even if a person is happy or sad prior to consuming the media, it is determined whether that person becomes happier or sadder as a result of consuming the media content.

The described method and system may be used for broadcast media content, such as television, or radio, including advertisements, shows, films, etc. Such content is consumed (viewed or listened to) by consumers and the described system allows consumers to activate at specific times or consent to continuous monitoring of their change in emotion whilst consuming the broadcast media content in order to receive content more appropriate to that consumer's reaction to the content.

The change in human emotion or the trend in emotion of a consumer may be affected by outside factors and/or may be affected by the consuming of the content. In either case, the content streamed to the consumer will be appropriate to the reaction of the consumer.

One particular instantiation of the described system may be a system, which targets different product advertisements based on the emotion reaction of a consumer. Different products could be targeted if someone becomes afraid (security products), sad (retail products), angry (political broadcasts of opposition parties, etc.). Such a system may also take into account other local data such as weather, crime in local areas, upcoming events, etc. to target these advertisements.

In a first example, a consumer may be viewing a movie. The consumer has activated an emotion monitoring device to enable him to receive appropriately targeted advertisements as he does not wish to view the general selection of advertisements normally received. The movie may be a scary movie and/or the consumer may be alone in the house and there may be a storm outside, for whatever reason, the consumer becomes afraid. The change in human emotion (becoming more nervous or scared) is determined and, based on this change, the system streams adverts for home security to the consumer. This is beneficial to the consumer who may not have realised he was feeling scared and would feel more secure with a home security system.

In a second example, a consumer may be viewing a television show and, more particularly, an advertisement break. A set of advertisements may be broadcast. The consumer particularly likes the advertisements about the latest smart phones. The changes or deltas in human emotion metrics (emotional response) to these advertisements may be monitored. The system may also measure the content itself (including possibly product placement and embedded subliminal content) and also the network infrastructure delivering that content. A correlation may be made between the emotional change of the consumer and the content being viewed as well as the quality of the content and the network itself. If the change in emotion is positive, indicating the consumer likes what the consumer are viewing, the system may control the media content streamed to the television screen and, for example, stream more advertisements about phones, for example, from different vendors. If the change in emotion is negative, a potential set of causes of this negative response is computed and (possible) action taken.

Product vendors and suppliers may subscribe to a service whereby, whenever a consumer's reaction is positive to a vendor's product as the consumer are viewing the product, would specifically transmit product information (in various forms, e.g. advertisements, SMS, etc.) to that consumer. Payment may be based on the number of targeted advertisements based on this positive emotional response of the consumer.

In a similar manner, with the consumer's consent, a consumer's emotion may be influenced on a targeted basis. After influencing the consumer's emotion, the consumer may be targeted with the most effective advertisement matching the consumer's changed emotion. The consumer may specify settings such as the emotion changes the consumer consent to. For example, always prefer a positive emotional change from sad to happy, agitated to calm, etc.

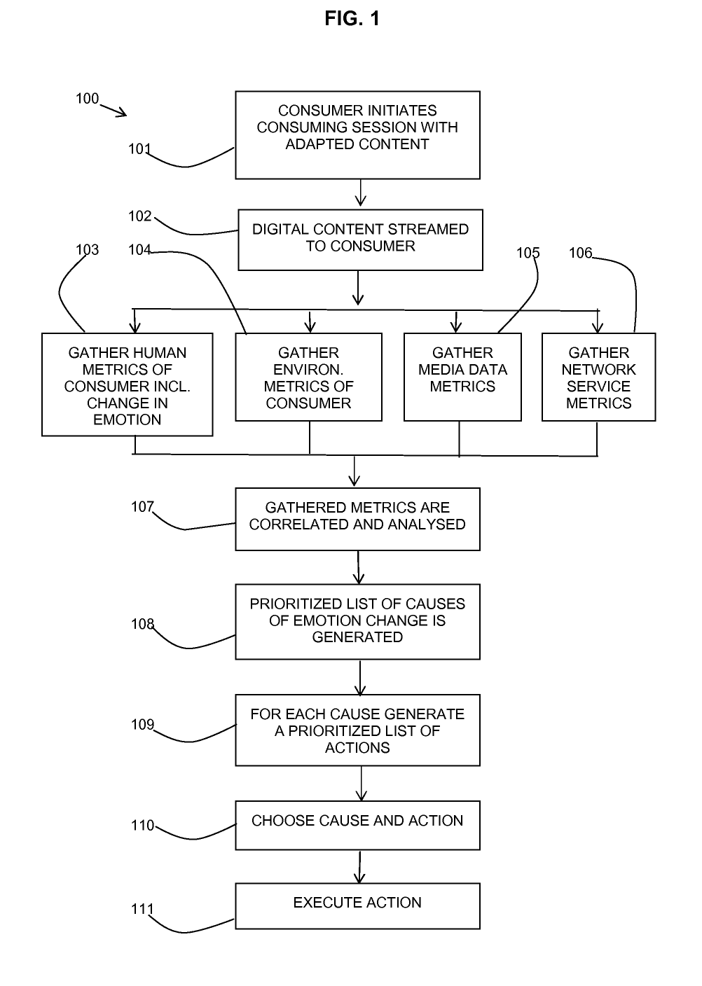

Referring to FIG. 1, a flow diagram 100 shows an embodiment of the described method.

A consumer initiates 101 a consuming session with adapted content. This may be by prior consent whenever a consumer switches on a television or radio, or selects a certain channel. Alternatively, this may be by a consumer selecting an adapted content whilst already receiving content. For example, a consumer may be watching a television channel and decides to activate an adapted personalised content option.

A consumer may browse the available digital content. This could be a television listing, a movie list, or any other digital media selection. The consumer may make a selection and the channel selection may be sent to a media controller which initiates the media stream to the consumer.

Digital content is streamed 102 to the consumer. In a commercial situation, other data and information may be part of this transmission. This other data may include advertisements from suppliers, shown for example at advertisement breaks, product placement, and even subliminal images may be embedded within the media stream itself.

The digital content streamed to the consumer may be scheduled content or may, optionally, be content intended to influence the specific consumer or a group of consumers. For example, a consumer may request that the streamed media influence his emotion to make him happier or more relaxed.

Various metrics may be gathered relating to the consumer's experience. Initial metrics may be gathered prior to the consumer consuming the content. For example, metrics may be gathered at periodic intervals prior to consumption starting and may be averaged to give a background metrics reading.

Human metrics may be gathered 103 from physiological sensors at the consumer's location used to determine a change in emotion of a consumer (an emotion delta). At least a first value and a second value of a human emotion metric may be gathered and compared to determine a change in emotion. The first value may be gathered prior to or during consumption of streamed digital media content and may be averaged over several readings. The second value of the human metric may be gathered during consumption of the streamed digital media content after the first value and, again, may be averaged over several readings. A change in emotion may be determined if the emotion delta exceeds a defined threshold.

Physiological sensors may physically monitor a person's biological metrics, for example, via a sensor touching the skin measuring skin temperature, moisture, and conductivity, or via a camera recording and interpreting facial expressions or body language.

Other human metrics which may be gathered 103 include a consumer's identity, gender, age, profession which may be gathered on the system at a registration process, and social network information which may indicate a consumer's emotional state. Access to social network information must be consented to by the consumer and, again, this may be part of a registration process.

Measurements may be taken periodically. The measurement period may be configured by the consumer, but default periods may be typically 10 seconds. As the measurements are collected, the measurements may be stored.

Analysis of the measured data may also be executed periodically, which again may be configured by the consumer or set by the system. Typical values for analysis may be every 15 minutes. Deltas in emotion may be calculated for each measurement. Maximum, minimum and average of deltas in emotion may be computed.

Other calculations such as rate of change of emotion may also be computed. Also a number of consecutive periods in which emotion has deteriorated may be computed.

All of these measurements may be compared against thresholds. For example, if someone is getting angrier for 10 consecutive periods, an action should be taken; if the delta in any periods jumps by more that 75% of an average, again an action should be taken; if the rate of change of emotion exceeds 50%, an action should be taken. These are some examples of the types of analysis that may be performed but clearly there can be many more.

Environment metrics may be gathered 104 at the consumer's location and may include ambient metrics such as the temperature of the room, illumination, smokiness, time of day, etc. and local metrics such as weather, local events, outside noise, etc.

Media data metrics may be gathered 105 and may include media content information and media quality information. Media data metrics may also include local ambient metrics such as temperature, noise.

The media content metrics may include: time period, media consumer ID (e.g. screen type, make, set-top box, subscription-type (e.g. Sky (Sky is a trade mark of News Corporation), Free-to-air, etc.), media type identifier (e.g. film, television listing, advertisement), sub-media identifier (e.g. subliminal images), human emotion value, human emotion delta value.

The media quality metrics may include: time period, media consumer ID (e.g. screen type, make, set-top box, subscription-type (e.g. Sky, Free-to-air, etc.), pixilation, peak signal to noise ratio (PSNR), structural similarity index (SSI), picture size and resolution, colour vividness, image sharpness, contrast, quality of motion, etc.

Network service metrics may be gathered 106 which may include time period, network node ID, jitter, delay, loss, etc.

The gathered metrics may be correlated and analysed 107. A prioritized list of causes may be generated 108 for the human emotion change monitored. For each cause, a set of prioritized actions may be computed 109 to target the media content for the consumer.

Either automatically or manually via a user interface, a cause and an action may be chosen 110. The action may then be executed 111.

Monitoring of all the metrics may be continued including the further changes in the consumer's emotion in response to the content change of the action. The method may be repeated to take further actions.

Actions taken may include the streaming of content similar in nature (e.g. advertisements of related products) if the change was positive or change to different content if change was negative. This can apply to other digital content also such as movies, television show, radio show, sports, etc.

Actions taken may also include changing aspects of the service delivery chain, e.g. satellite provider, set top box, television screen (e.g. if resolution is bad). Actions may also include changing aspects of the network service delivery chain.

Other actions may include matching the human emotion to a specific product class or a particular supplier based on subscription.

These actions may be automatically invoked.

The actions may be applied to a broader set of consumers, such as all consumers with same profile as the consumer (for example, age, location, salary scale, etc.).

A log of actions and their effects on consumers may also be stored and used as evidence by the broadcaster of the effectiveness of an advertisement.

Various advertising charging scenarios and marketing packages may be devised.

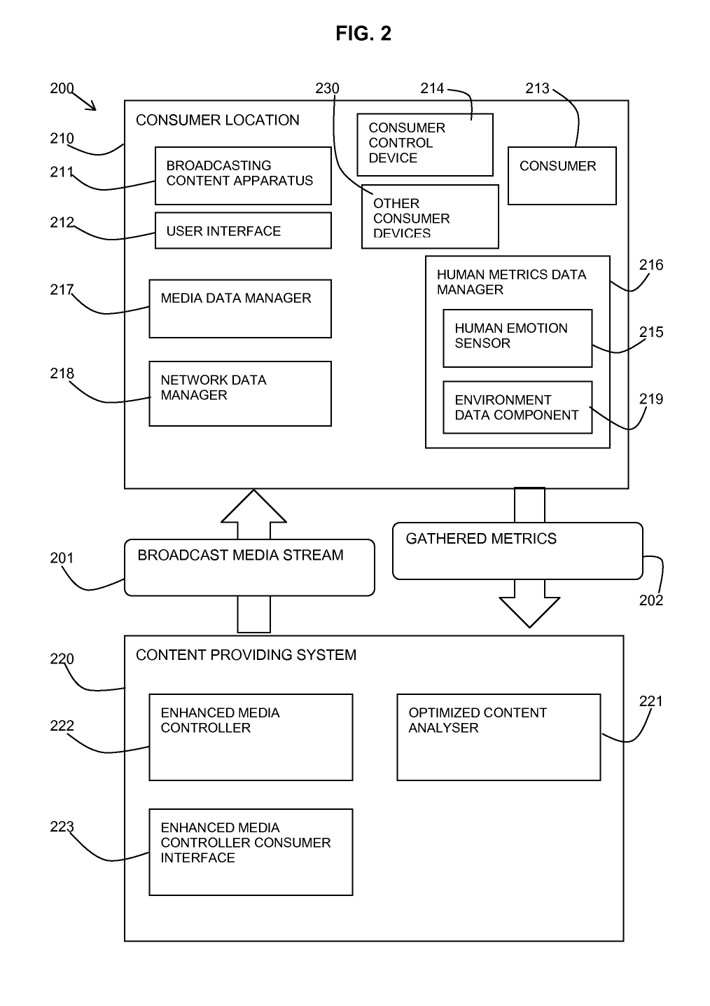

Referring to FIG. 2, an embodiment of the described system 200 is shown.

A consumer location 210, such as a room in a house or apartment, contains the broadcasting content apparatus 211 such as a television, radio, etc. with a user interface 212 such as a television screen, radio speaker, etc.

A consumer 213 may operate a consumer control device 214 to operate the broadcasting content apparatus. The consumer control device 214 may also operate the described adaptive content system to activate the adaptive content system or deactivate the adaptive content system or to consent to having the adaptive content system continually operational.

A human metrics data manager 216 may be provided including a human emotion sensor 215 for sensing physiological indications of emotion. The human emotion sensor 215 may include a software system, either in the television itself, the setup box, remote control, etc. for measuring the human emotion metrics and the changes or deltas in human emotion metrics (emotional response).

The human metrics data manager 216 may store and compute deltas, key performance indicators (KPIs), etc. in human emotion of the consumer. Alternatively, the human metrics data manager 216 may gather the metrics and forward the metrics for analysis at the content providing system 220.

An environmental data component 219 may be provided to gather additional human environment data. The human metrics may also be augmented with the permission of the consumer by other sources of data relating to the consumer such as social networks of the consumer. Ambient metrics such as temperature of the room, smokiness, etc. may also be collected. Local metrics such as weather, local events, outside noise, etc. may also be collected and taken into account.

The KPI's computed may include value(s) of human emotion over time, the delta or change in emotion over time per consumer. In one embodiment, the following information may be computed by the human metrics data manager 216 at each time period: consumer ID, location, time period, ambient metrics (temperature, light/dark, etc.), human emotion, human emotion delta.

A media data manager 217 may be provided for collecting and computing media content metrics, and media quality metrics. The media data manager 217 may also collect local ambient metrics such as temperature, noise, etc.

A network data manager 218 may be provided for collecting and computing network service delivery metrics. The network data manager 218 may also collect other metrics weather information, broader human emotion metrics from social network databases, crime information, local events.

Remote from the consumer location 210, a content providing system 220 may be provided. The consumer location 210 and the content providing system 220 may be in communication via a wireless, satellite, network, or other communication. A broadcast media stream 201 is sent by the content providing system 220 to the consumer location 210 and gathered metrics 202 are sent from the consumer location 210 to the content providing system 220.

A consumer 213 at the consumer location 210 may also have other devices 230 on which content may be received, for example, advertisement to a mobile telephone device in addition to the broadcast content on a television.

The content providing system 220 may include an optimized content analyser 221 which may correlate all the information gathered from the consumer location 210 including from the human metrics data manager 216, media data manager 217 and network data manager 218. The optimized content analyser 221 may produce a prioritized list of potential causes why the emotion of the consumer has changed. Additionally, the optimized content analyser 221 may generate a revised set of recommendations of media content changes based on the causes. the optimized content analyser 221 may send this information to an enhanced media controller 222 and also to an enhanced media controller user interface 223.

The enhanced media controller 222 may processes the information sent by the optimized content analyser 221 and based on its rules and the configuration, the enhanced media controller 222 may take action.

In terms of configuration, the following may be supported:
1. Yes/No—Take automatic action based on prioritized causes;
2. Yes/No—On a per consumer subscription basis, has consumer subscribed to the feature;
3. Yes/No—On a vendor and product basis: has the vendor paid for participation in this service.

The purpose of the actions is to ‘improve’ the human emotion of the consumer.

If the human emotion of the consumer was happy (or getting happier), then the action may be to keep things the same. If the cause of this emotion was deemed to be the content of the media, then actions could be taken to maintain or improve the content.

If the delta in emotion is positive, i.e. the consumer enjoyed the content, then take action and revise the content delivered to keep the consumer happy or make the consumer even happier. For example, if the consumer was watching advertisements and enjoyed the advertisements, stream more advertisements from the same product vendor or product type, for example, mobile phones. If the consumer was watching a movie of a certain genre and enjoyed the movie, then recommend similar movies from same director, main actors, etc., for example, in next set of advertisements. It may be that the media quality was poor and the action is to stream the content via a backup medium such as fibre optic. It may be that the network was poor and the action is to choose a new route.

If the delta in emotion is negative, i.e. the consumer did not enjoy the content, then take action and revise the content delivered.

If the human emotion of the consumer was nervous or afraid, then the action may be to make the consumer calmer or feel safer. For example, this could mean streaming home security advertisements, or other actions such as increasing the temperature of the room, or contact (via social network) their friends to make contact.

An enhanced media controller user interface 223 may be provided which displays the prioritized list of potential causes of change in emotion of a consumer. An operator may take manual action to revise the content or let the enhanced media controller revise the content.

Revised digital content may be streamed to the consumer including advertisements, metadata, etc. or via an alternative device such as a mobile phone if registered with the service.

The described system may influence the emotion of consumers on an individual or targeted basis as long as the consumer's have provided prior agreement to such influence. After influencing the emotion, individual consumers may be targeted with the most effective advertisement matching the actual emotion.

In the processing of metrics, an algorithm may be provided that would take various factors into account regarding multiple consumers at the same location, including the following:
Who holds the remote control device;
The emotional state of each consumer;
The available advertisements;
The historical data relating to each consumer;
Alternatively or additionally, using existing social networking methods to detect an individual consumer's emotional state;
Using social networks to prioritize adverts in a multi-consumer situation, i.e. social standing, key-influencer, etc.

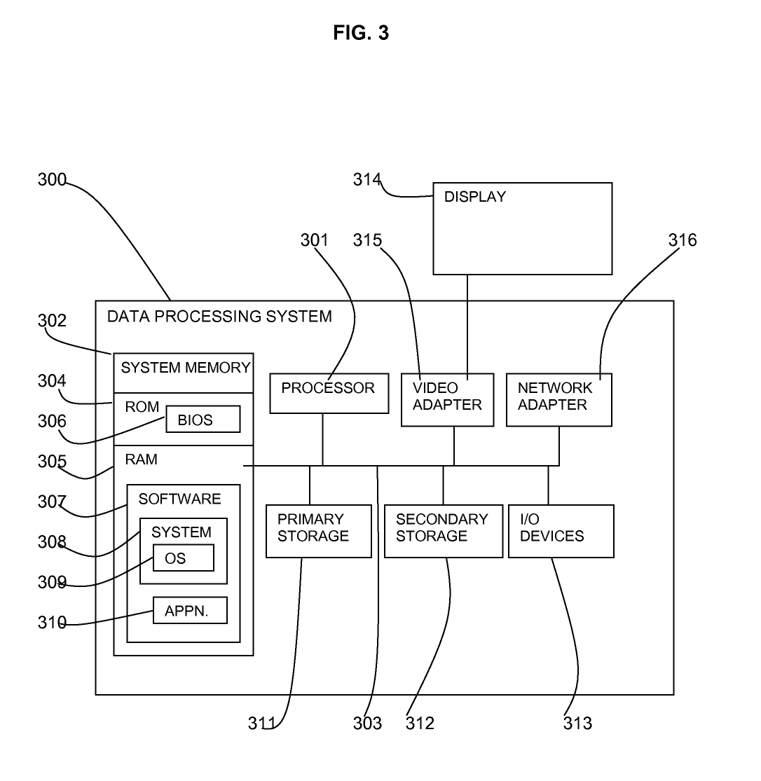

Referring to FIG. 3, an exemplary system for implementing aspects of the invention includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A consumer may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

Evaluating television consumers watching habits accurately is very importance for advertisers. Advertisers increasingly need television programmers and distributors to account for how many consumers are reached. Moreover, advertisers are attempting to aim advertising directly at the consumers the advertisers most want to reach with advertisements that appeal to those specific consumers based on their viewing habits and demographics.

The described method and system proposes, should a consumer request, that the broadcaster can in real time adjust the media stream delivered to consumers, based on measuring the changing mood of the viewing audience as well as other metrics. This provides an improved experience for a consumer who is not bombarded with irrelevant information.

A software system performing the function defined here benefits both the consumer (the consumer gets to view content that the consumer is interested in) and the content provider (the content is displayed to consumers that are interested in the product and who may buy the product). The enhanced digital media content delivery system enabled by these enhancements will further improve the quality of experience of people viewing the content and also potential sales of the product vendors advertising through this medium.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

1. A method for targeted digital media content delivery, comprising:
receiving activation of a targeting service by a consumer;
determining a first value of a human emotion metric corresponding to a mood of the consumer at a first time;
determining a second value of the human emotion metric corresponding to the mood of the consumer at a second time while consuming digital media content;
comparing the first value of the human emotion metric with the second value of the human emotion content in order to determine a change in emotion of the consumer; and
targeting the digital media content in accordance with the change in emotion of the consumer.

2. The method as claimed in claim 1, further comprising:
determined a change in emotion, if the change exceeds a defined threshold.

3. The method as claimed in claim 1, wherein determining the first value of the human emotion metric is carried out before consumption of the digital media content or during consumption of the digital media content but before the second time.

4. The method as claimed in claim 1, further comprising:
receiving a request from the consumer for the consumer's emotion to be influenced; and
streaming the digital media content intended to influence an emotion of the consumer.

5. The method as claimed in claim 1, further comprising:
gathering human emotion metrics from physiological sensors at a location of the consumer.

6. The method as claimed in claim 1, further comprising:
gathering human emotion metrics from consumer information including social network information.

7. The method as claimed in claim 1, further comprising:
gathering environmental metrics relating to an environment of the consumer.

8. The method as claimed in claim 1, further comprising:
gathering media data metrics relating to the digital media content and media quality.

9. The method as claimed in claim 1, further comprising:
gathering network data metrics relating to network service delivery.

10. The method as claimed in claim 1, further comprising:
correlating gathered metrics and the change in emotion of the consumer;
generating a prioritized list of potential causes for the change in emotion.

11. The method as claimed in claim 10, further comprising:
taking action according to the prioritized list of potential causes, wherein an action includes one of the group of: streaming of content similar in nature, changing to different content, changing aspects of the service deliver chain, changing aspects of the network service delivery chain, matching the human emotion to a specific product class, or a particular supplier based on subscription.

12. The method as claimed in claim 11, wherein taking action is applied to a set of consumers with a common profile to the consumer.

13. The method as claimed in claim 11, further comprising:
maintaining a log of actions and effects of the actions on a set of consumers.

14. A system for targeted digital media content delivery, comprising:
a processor;
a memory coupled to the processor, wherein the memory comprises instructions which, when executed by the processor, cause the processor to:
receive an activation of a targeting service by a consumer;
determine a first value of a human emotion metric corresponding to a mood of the consumer at a first time;
determine a second value of the human emotion metric corresponding to the mood of the consumer at a second time while consuming digital media content;
compare the first value of the human emotion metric with the second value of the human emotion metric in order to determine a change in emotion of the consumer; and
target the digital media content in accordance with the change in emotion of the consumer.

15. The system as claimed in claim 14, wherein the instructions further cause the processor to:
gather human emotion metrics from physiological sensors at a location of the consumer; and
gather human emotion metrics from consumer information including social network information.

16. The system as claimed in claim 14, wherein the instructions further cause the processor to:
gather environmental metrics relating to an environment of the consumer.

17. The system as claimed in claim 14, wherein the instructions further cause the processor to:
gather media data metrics relating to the digital media content and media quality.

18. The system as claimed in claim 14, wherein the instructions further cause the processor to:
gather network data metrics relating to network service delivery.

19. The system as claimed in claim 14, wherein the instructions further cause the processor to:
correlate gathered metrics and the change in emotion of the consumer; and
generate a prioritized list of potential causes for the change in emotion.

20. The system as claimed in claim 19, wherein the instructions further cause the processor to:
take action according to the prioritized list of potential causes, wherein an action includes one of the group of: streaming of content similar in nature, changing to different content, changing aspects of the service deliver chain, changing aspects of the network service delivery chain, matching the human emotion to a specific product class or a particular supplier based on subscription.

21. The system as claimed in claim 20, wherein taking action is applied to a set of consumers with a common profile to the consumer.

22. A computer program product comprising computer readable storage medium having a computer readable program stored therein, wherein the computer readable program, when executed on a computing device, causes the computing device to:
receive an activation of a targeting service by a consumer;
determine a first value of a human emotion metric corresponding to a mood of the consumer at a first time;
determine a second value of the human emotion metric corresponding to the mood of the consumer at a second time while consuming digital media content;
compare the first value of the human emotion metric with the second value of the human emotion metric in order to determine a change in emotion of the consumer; and
target the digital media content in accordance with the change in emotion of the consumer.
